(19) United States
(12) Patent Application Publication
(10) Pub. No.: US 2011/0106674 A1
(43) Pub. Date: May 5, 2011

(54) Optimizing Transaction Scenarios With Automated Decision Making

(76) Inventor: Jeffrey William Perlman, Gordon NSW (AU)

(21) Appl. No.: 12/778,446

(22) Filed: May 12, 2010

Related U.S. Application Data
(60) Provisional application No. 61/256,141, filed on Oct. 29, 2009.

(51) Int. Cl. G06Q 20/00; G06Q 10/00; G06Q 40/00

(52) U.S. Cl. 705/30; 705/35; 705/44

(57) ABSTRACT

An example computer-implemented method of processing transactions in a funds facilitation system includes the steps of: receiving an electronic funding request to provide a payment for a transaction; identifying characteristics of the transaction based on information provided in the funding request; comparing the characteristics of the transaction with transaction rules stored in a rules database to determine at least one of: (a) a payment source for funding the funding request, and (b) an authentication procedure for authorizing the funding request. The selection of the authentication procedure is based at least in part on a stored trust level associated with a source of the electronic funding request. The receiving, identifying, and comparing steps are performed by software executable on one or more data processors. A funds facilitation system and memory structure are also included.

### CROSS-REFERENCE TO RELATED APPLICATION

This application claims the benefit of priority from U.S. Provisional Application No. 61/256,141, filed on Oct. 29, 2009. This prior application, including the entire written description and drawing figures, is hereby incorporated into the present application by reference.

### TECHNICAL FIELD

The present disclosure relates generally to computer-implemented systems and methods for conducting transactions over a network.

### BACKGROUND AND SUMMARY

Electronic commerce, commonly known as electronic marketing, e-commerce, or eCommerce, consists of the buying and selling of products or services over electronic systems such as the Internet and other computer networks. The amount of trade conducted electronically has grown extraordinarily with widespread Internet usage. Commerce conducted in this manner utilizes a complex web of innovations in electronic funds transfer, supply chain management, Internet marketing, online transaction processing, electronic data interchange (EDI), inventory management systems, automated data collection systems, and many others. Modern electronic commerce typically uses the World Wide Web at least at some point in the transaction's lifecycle, although it can encompass a wider range of technologies such as e-mail as well.

With the continued increase in competition on the web, product, content, and service providers must strive to not only produce the best products, content, and services, but they must also compete to offer the most intuitive, secure, and fast mechanisms for accepting payments and providing their wares to interested consumers. Some consumers are reluctant to use e-commerce because of fears of theft of their personal/financial information and/or because of the time-consuming nature and complexity of setting up and using electronic accounts with each merchant and funds facilitation system.

The systems and methods disclosed herein offer enhanced security, speed, and ease of use for e-commerce funds facilitation systems by utilizing rule-based default decision-making. Distinctions are made between low and high value transactions and whether the payment has a trusted relationship with the merchant.

Disclosed herein is an example computer-implemented method of processing transactions in a funds facilitation system. The method includes the steps of: receiving an electronic funding request to provide a payment for a transaction; identifying characteristics of the transaction based on information provided in the funding request; comparing the characteristics of the transaction with transaction rules stored in a rules database to determine at least one of: (a) a payment source for funding the funding request, and (b) an authentication procedure for authorizing the funding request. The selection of the authentication procedure is based at least in part on a stored trust level associated with a source of the electronic funding request. The receiving, identifying, and comparing steps are performed by software executable on one or more data processors.

In another example, a computer-implemented system includes a funds facilitation system, a user account data store, a payment source, and a trusted third-parties database. One or more processors operate to: receive an electronic funding request to provide a payment for a transaction, identify characteristics of the transaction based on information provided in the funding request, and compare the characteristics of the transaction with transaction rules stored in a rules database to determine at least one of: (a) a payment source for funding the funding request, and (b) an authentication procedure for authorizing the funding request. The selection of the authentication procedure is based, at least in part, on a stored trust level associated with a source of the electronic funding request.

In a further example, a memory for storing data for access by an account processor in a funds facilitation system, includes: a user account data structure comprising account user ID information associated with payment source data, the payment source data comprising stored-value account information, a stored-value account balance, an additional account information. The account user ID information is further associated with a threshold transaction value. A general data structure is also included and comprises (1) a rules database comprising rules for determining at least one of: (a) a payment source for funding the funding request, and (b) an authentication procedure for authorizing the funding request; and (2) an authentication database comprising a list of trusted third parties, the rules database being associated with the stored-value account balance, the threshold transaction value, and the trusted third party database.

In another example, a computer-implemented system for processing transactions includes: means for receiving an electronic funding request to provide a payment for a transaction; means for identifying characteristics of the transaction based on information provided in the funding request; and means for comparing the characteristics of the transaction with transaction rules stored in a rules database to determine at least one of: (a) a payment means for funding the funding request, and (b) an authentication means for authorizing the funding request. The selection of the authentication means is based at least in part on a stored trust level that is associated with a source of the electronic funding request.

The details of one or more embodiments are set forth in the accompanying drawings and the description below. Other features, aspects, and advantages of the invention will become apparent from the description, the drawings, and the claims.

### BRIEF DESCRIPTION OF THE DRAWINGS

For the present disclosure to be easily understood and readily practiced, the present disclosure will now be described, for purposes of illustration and not limitation, in conjunction with the following figures.

FIG. 1 is a block diagram illustrating a system upon which the methods of the present disclosure may be practiced.

FIGS. 2A and 2B (referred to collectively as FIG. 2) are a block diagram of a method of conducting low-value transactions from stored values according to the present disclosure.

FIG. 3 illustrates an example user interface on a seller site.

FIG. 4 is an example of a sign-in screen user interface.

FIG. 5 is an example of a sign-in screen user interface.

FIG. 6 is an example of a user interface for creating an account.

FIG. 7 is an example of a purchase authorization user interface.

FIG. 8 is an example of a user interface for enabling reactivation of an account.

FIG. 9 is an example of a user interface informing a user that a transaction has already been processed.

FIG. 10 is a block diagram of an example method of conducting higher value “pass through” transactions.

FIG. 11 is one example of a purchase authorization user interface when funds are sufficient.

FIG. 12 is one example of a purchase authorization user interface when the funds are insufficient.

FIG. 13 is a third example of a purchase authorization user interface.

FIG. 14 is block diagram illustrating an example method of fulfilling payment requests.

FIG. 15 illustrates example user hardware on which the various embodiments may be practiced.

Like reference numbers and designations in the various drawings indicate like elements.

### DETAILED DESCRIPTION

In completing a transaction, there are many options as to how the transaction may be completed and from what funding/payment source as well as options which are driven by the availability and status of these sources. The systems disclosed herein addresses many aspects of the specific transaction and the purchaser's account profile, funds status, and funding options in order to modify the transaction experience to best cater to the specific combination—evaluating these transactions factors in real-time when a transaction is requested. The systems disclosed herein have the ability to deliver many different combinations of functions in the transaction experience to customize it for an extensive number of possible transaction scenarios.

One aspect of the present disclosure is to enable low-value transactions to be conducted from a stored-value balance, including the steps of creating a keyboardless transaction session with any seller. By “keyboardless” it is meant that the user may, for example, make only an input on the graphical user interface, such as by clicking on a “pay” button. This is in contrast to the more time consuming process of having to enter payment account and personal information. Entering such information and sending it over the internet also increases the risk of the information being stolen.

Another aspect of the present disclosure is to enable higher value “direct” transactions to be conducted directly from a default third-party payment source, e.g. a credit, debit, or prepaid card or a bank account.

According to one embodiment, a computer implemented method of processing transactions comprises executing instructions in a processor-implemented system for retrieving user data from a user data store and customizing a transaction authorization according to the retrieved user data. In variations of that embodiment, a transaction amount and/or merchant data and or payer account data/parameters may be used as additional input in the customization of the transaction authorization. According to another embodiment, a computer implemented method of processing transactions comprises executing instructions in a processor-implemented system for passing control of a transaction from a merchant site to a third party payment site, where the user login at the merchant site acts as a proxy for the third party payment site. Instructions are executed at the third party payment site to retrieve user data from a user data store. A customized authorization is delivered to a user site based on the retrieved user data. The customized authorization may be further customized based on the value of the transaction and merchant and payer account information.

In one embodiment, one or more payment sources are checked to determine if sufficient funds are available prior to attempting to fulfill the electronic funding request by attempting to withdraw funds from the payment source(s). This is contrasted with, and may exclude attempting to withdraw funds and upon failure of such attempts, attempting to fund the request from another payment source. This approach allows the original transaction requested to succeed despite there being insufficient funds in one or more payment sources. Using a standing order to select a payment source that can provide sufficient funds as a first priority before fulfilling the requested transaction, for example without first failing the transaction attempt, is more efficient from both a processing time/effort view and a data record view.

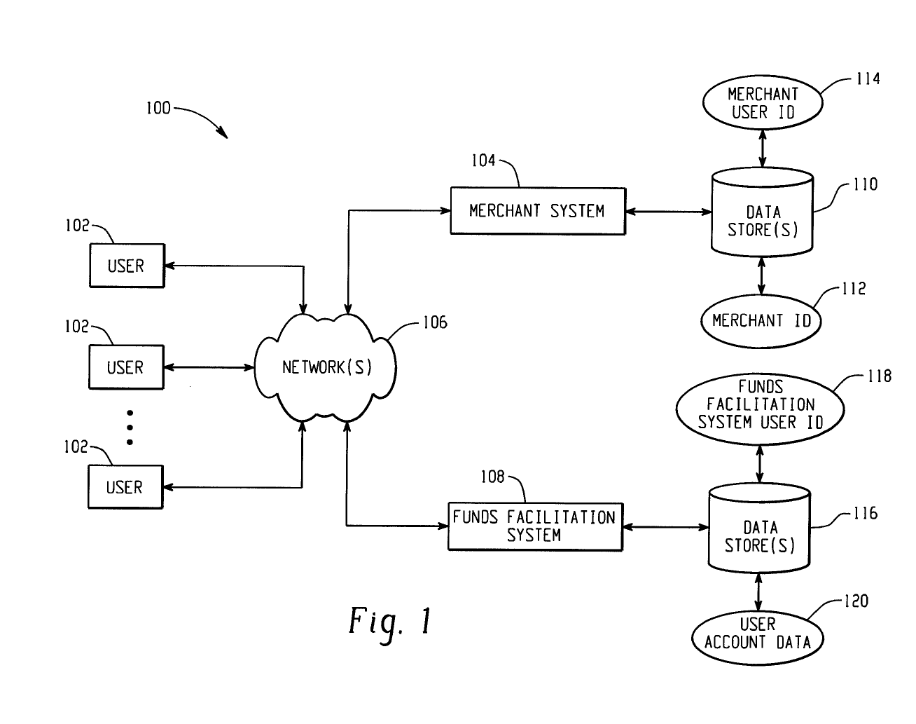

FIG. 1 depicts at 100 a computer-implemented environment wherein users 102 can interact with a merchant system 104 hosted on one or more servers through a network 106. The system 104 contains software operations or routines for receiving a transaction request from a user 102 and providing fulfillment or notice of fulfillment of the requested transaction or a denial of the transaction request to the user 102. The users 102 can interact with the merchant system 104 through a number of ways, such as over one or more networks 106. One or more servers accessible through the network(s) 106 can host the merchant system 104.

The computer-implemented environment further includes a funds facilitation system 108. The funds facilitation system 108 may be configured for identifying the availability of funds in a user account, acquiring funding for a user account, identifying conditions and or restrictions for a user account, identifying the type of user account and the rules, conditions, and/or permissions that may apply to the specific type of account, identifying conditions and or restrictions imposed on a sponsored user account by a sponsoring user account, disbursing funding to a merchant to pay for a merchant performing a transaction, for determining whether a merchant should or should not perform a transaction, identifying whether the user account and merchant are allowed to transact with each other based on type, classification, and other parameters, and rules on either or both accounts, as well as other operations. The funds facilitation system 108 is hosted on one or more servers through one or more networks 106.

In an example operation, a user 102 accesses a web page hosted on the merchant system 104 via the one or more networks 106. For example, the web page may list a number of book titles that are available for download from the merchant system in exchange for a payment from the user. The user 102 indicates his desire to download one of the listed books by clicking a button on the web page that initiates a transaction request to the merchant system 104.

Upon receipt of the transaction request, the merchant system 104 prepares a transaction authorization request for authorization of and facilitating payment for the transaction requested by the user 102. The merchant system 104 may access one or more data stores 110 to acquire a merchant ID 112 identifying the merchant system 104. The merchant system 104 may further access the one or more data stores 110 to access a merchant user ID 114 associated with the user 102 that provided the transaction request. The merchant user ID 114 associated with the user 102 may be identified based on a prior user identification at the merchant system 104, such as the user 102 providing a username and password combination. The merchant system 104 packages the merchant ID 112 and the merchant user ID 114 as well as a transaction amount associated with the transaction requested by the user 102 into a transaction authorization request that is transmitted to the funds facilitation system 108 via the one or more networks 106.

The funds facilitation system 108 receives the transaction authorization request from the merchant system 104 and accesses one or more data stores 116 responsive to the funds facilitation system 108 to identify a funds facilitation system user ID 118 associated with the merchant user ID included in the transaction authorization request. The funds facilitation system user ID 118 accessed by the funds facilitation system 108 provides a link to user account data 120 for the user 102 that provided the transaction request. The user account data 120 may include data related to one or more accounts related to the user 102 including prepaid accounts, stored-value accounts, credit accounts, debit accounts, or the like. In one embodiment, the prepaid accounts may be useful for conducting low-value transactions. In another embodiment, the account may be a credit, debit, or other account (or an alias for such an account) that may be more appropriate for higher value transactions. The funds facilitation system 108 may determine the viability of the transaction described in the transaction authorization request from the merchant system 104 based on the provided transaction amount, a funds available value from the user account data 120, as well as other user account settings and data and other criteria. For example, other user account settings, data, and other criteria include: system or user set value parameters that associate specific payment sources with specific value thresholds or ranges; rules on either or both of the user and merchant accounts (e.g. spending limits by merchant or merchant type); category of merchant and restrictions which may apply to that category independent of or in combination with the user account; type of user account (e.g. verified as safe harbor, unverified, or sponsored) and rules associated with that type of user account; category of item being purchased and restrictions that may apply to that product category independent of or in combination with the user account; conditions of the merchant in relation to the geographical location of customers as stated in the user account data; conditions allowing certain transactions only if the transaction can be funded from a specific funding source.

If the funds facilitation system 108 determines that the proper criteria for a transaction approval are met, the funds facilitation system 108 may transfer the transaction amount from the user's account to the merchant and provide a transaction authorization to the merchant system 104. Upon receipt of a transaction authorization from the funds facilitation system 108, the merchant system 104 may make the book title available for immediate download by the user 102 with the knowledge that compensation for the transaction has been provided to the merchant.

While the above example describes providing a digital book to a user 102 in response to a transaction request, the system 100 may be utilized in a multitude of other scenarios. For example, instead of providing immediate digital content, the merchant may instead mail a physical product to the user 102 or perform a service, such as a healthcare service, for the user 102 upon receipt of a transaction authorization.

The funds facilitation system 108 may comprise one or more servers containing software operations or routines for creating and maintaining accounts for the users; for enabling the users to conduct transactions with one or more websites; for enabling users to initiate dispute proceedings with one or more websites and to automate the communications related to the dispute and the resolution of the dispute; to initiate and transmit alerts to users, websites, and/or system administrators based upon pre-defined and/or customizable parameters; to configure and apply fees to all transactions; and to conduct reporting as may be relevant to the websites, the account processor, and/or the users. Furthermore, the one or more servers of the account processor may additionally contain software operations or routines related to managing the accounts (such as by updating billing addresses, delivery addresses, user preferences, and the like); for enabling users to authorize and manage recurring payments or to pre-authorize payments; for enabling users to pre-authorize or prohibit (i.e., blacklist) websites or merchant categories and/or transactions; and/or for enabling users to manage accounts and conduct transactions using mobile electronic devices or any other electronic device such as internet-connected gaming consoles, a digital set-top box, or similar devices.

The funds facilitation system 108 applies transaction rules to automatically determine the payment source and the transaction method. For example, the transaction rules may be applied to determine whether a transaction amount threshold is met and/or whether a desired trust level status of the party requesting payment is met. In one example, the transaction rules may be used to determine whether a transaction request is from a new user, which will require registration prior to payment. The transaction rules may also be used to separately record high-value and low-value transaction based on a threshold level. The transaction rules may determine whether the user would like any physical products shipped to a certain address, and can compare the user's requested delivery address with the geographical range (e.g. by country or post code) to which a merchant account data and or specific data in the transaction request indicates it will ship to, request a different address from the user if the provided address does not meet these criteria, and relay this information automatically to the party requesting payment.

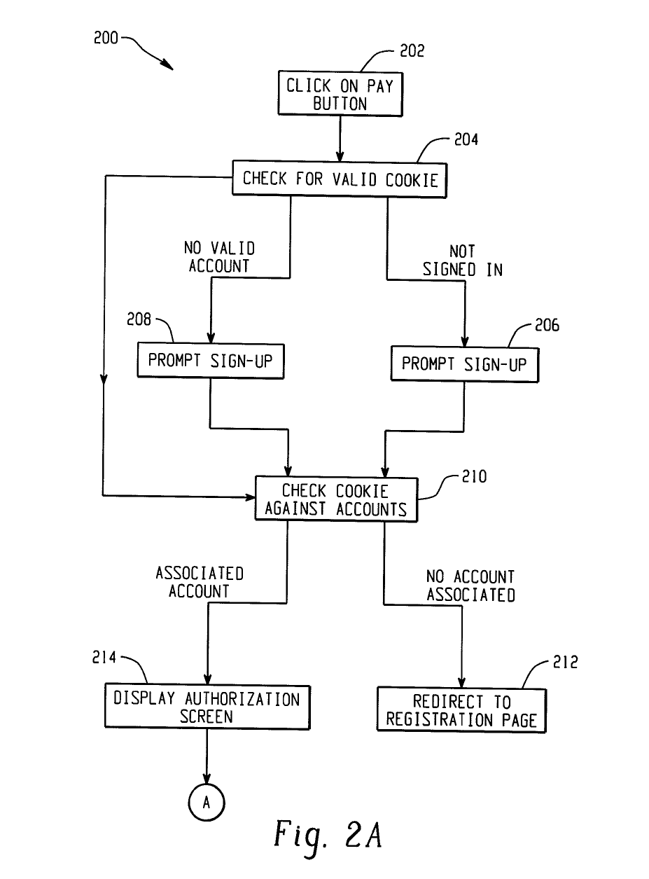

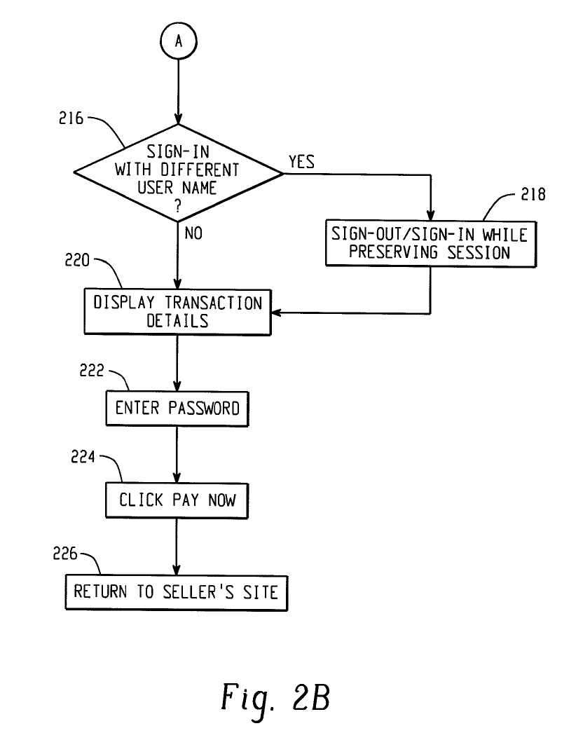

One aspect of the present disclosure is to enable an in-line transaction (200 in FIG. 2) with any seller to be conducted for a low-value purchase from a stored-value account, including multiple permutations/scenarios.

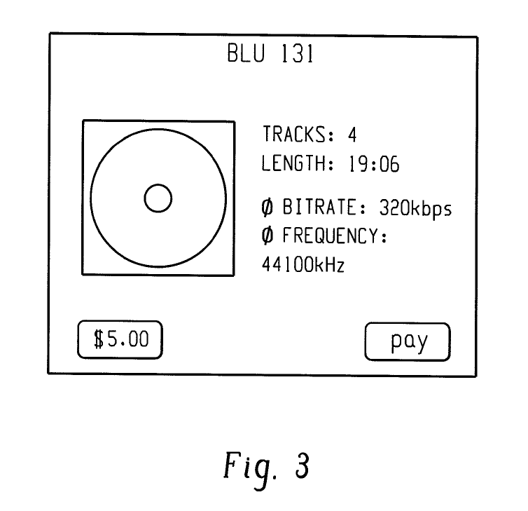

In one example of a low-value type of transaction, when a transaction amount is less than a threshold amount then the transaction is funded from a stored-value account, if the stored-value account has a stored-value balance sufficient to fund the transaction amount. The fulfilled transaction results in the transaction amount being decremented from the stored-value account balance. In an example of this process, a user clicks on a button on a seller site (either on an individual catalogue item or in the checkout process) as shown at 202 in FIG. 2. A screen shot of an exemplary screen at this point in the process is illustrated in FIG. 3. This action may transfer control of the transaction to a third party site/payment service such as the disclosed service. The user login at the merchant site may act as a proxy for the login and or security key needed for the third party payment site.

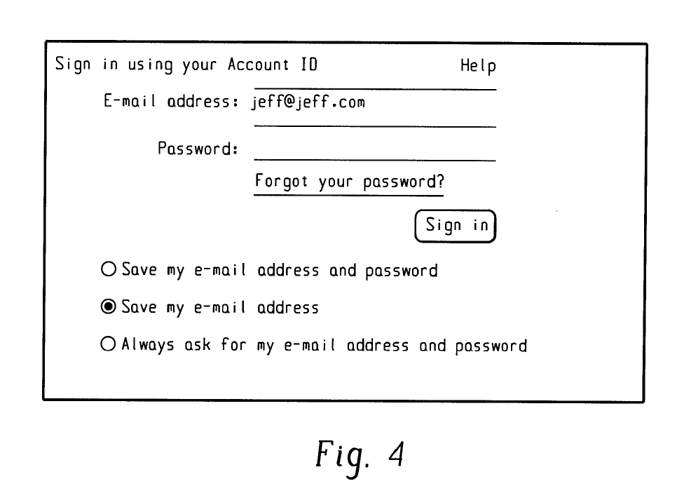

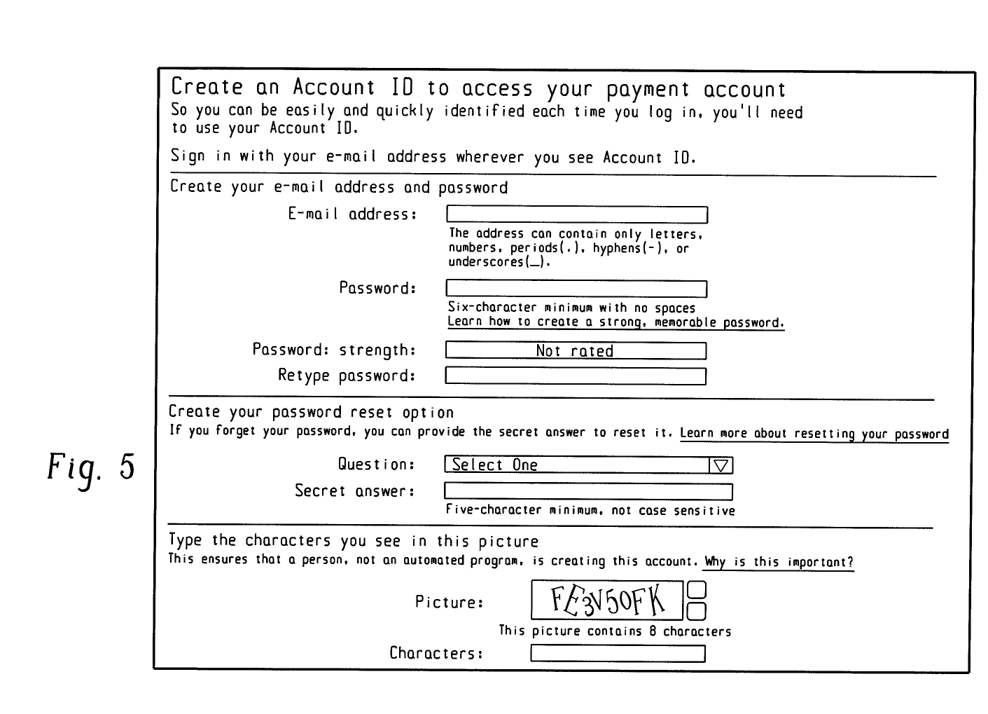

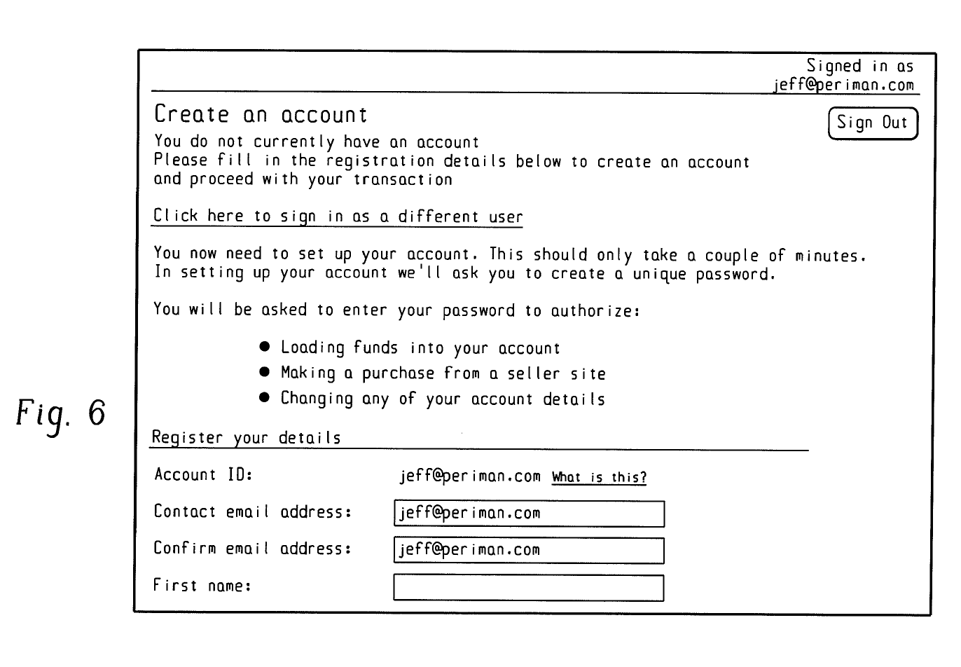

The service checks at 204 for a valid (ACCOUNT ID) cookie (logged in session state). The ACCOUNT ID cookie may be an open or proprietary authentication protocol, such as Open ID. If the ACCOUNT ID cookie is not present on the client, the service prompts the user at 206 to Sign In to ACCOUNT ID. An exemplary sign-in window is illustrated in FIG. 4. If the user has no ACCOUNT ID account, the user is prompted to sign up for one at 208. Signing up for an account may be a one-step process. An exemplary sign-up window is illustrated in FIG. 5. If the ACCOUNT ID cookie is present (or after Sign In or Sign Up), the system checks the ACCOUNT ID cookie against the accounts at 210. If no account is associated with this ACCOUNT ID cookie, the user is redirected at 212 to a registration page, which may be delivered under a seller co-branded header. An exemplary screen for creating an account is illustrated in FIG. 6. The type of accounts that can be set up may vary from the standard account that can be set up using the screen shown in FIG. 6 to a sponsored account that may be used for a minor.

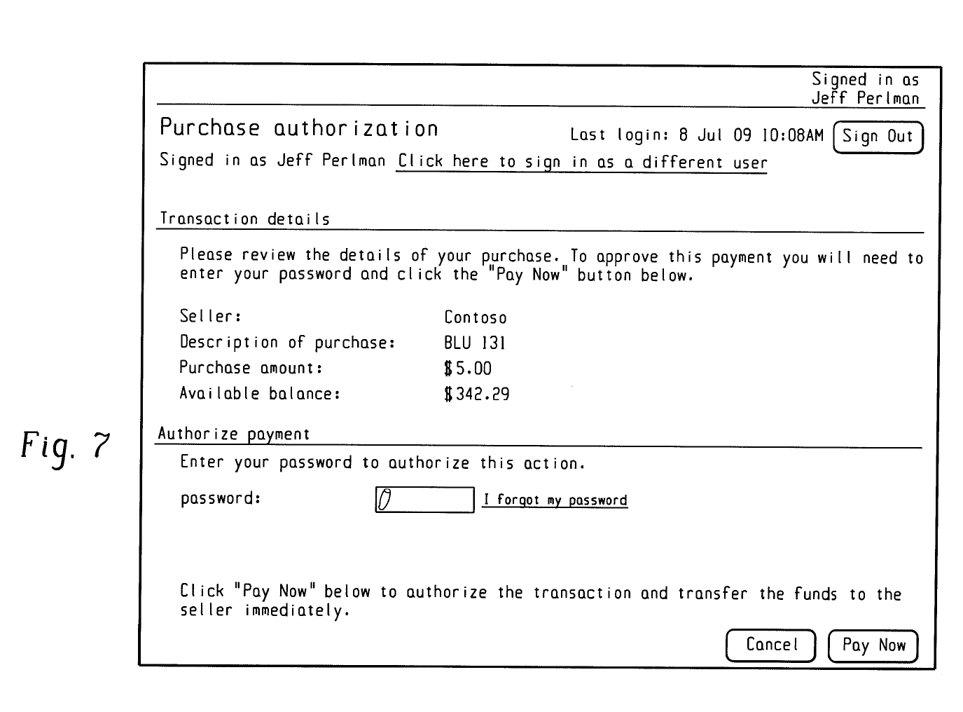

If the ACCOUNT ID cookie is present and is associated with an account, then the user is redirected to a seller co-branded payment authorization screen (see FIG. 7) as shown at 214 in FIG. 2.

The authorization screen in FIG. 7 displays “Signed in as [username].” If the “Signed in as” name is not the current user, the user can “Click here to sign in as a different user” at 216. If yes, the user is signed out of ACCOUNT ID and then allowed to sign in while preserving the transaction session at 218. The current user would need to know the signed-in-as user's password to “accidentally” complete this transaction on the signed-in user's account.

At this point, the user sees Seller name, Description of purchase, Purchase amount, and Available balance in his or her account (this last piece of data is the only data made accessible to this interface as a result of the ACCOUNT ID Silent Sign-on cookie which allows the system to recognize the account of the current user) as shown at 220.

The user enters the password to authorize payment at 222; the user clicks “Pay Now” at 224, and the user is returned to the seller site at 226 with a transaction response message. At this point the seller progresses the order accordingly, e.g., by providing a link to download a purchased song.

As mentioned above, if the username displayed is not that of the current user, then the current user has the option to “Click here to sign in as a different user” at 216. When clicked, this signs out the ACCOUNT ID for the Signed-in user, allows the current user to sign in, and preserves the transaction authorization session, returning the current user to the co-branded payment authorization screen as shown at 218.

If the transaction exceeds a stored-value balance but is under the “low-value threshold,” then at step 214, the authorization screen includes an additional form which enables funds to be added to the account. As funds need to be immediately available, the option to top-up from a bank account is not included in the in-line interface. Entering the password authorizes both the loading of funds and the in-line transaction in a single step. The payment processing system then processes these sequentially, first topping up the account from an external funding source, and if the top-up is successful, then processing the stored value transaction.

If the transaction exceeds the stored-value balance but is under the “low-value threshold” and a value-based recurring load is triggered as part of the transaction, then at step 214, the Available Balance shown is less than the Purchase Amount, and a message is displayed on the authorization screen that says “You do not have sufficient funds in your account to proceed with this transaction. Your preset recurring load will automatically add $50 from George's Visa to your account in order to complete this transaction.” Entering the password triggers the recurring load and authorizes the in-line transaction in sequence. For example, a preset recurring load may be set to add a specific amount, whenever the stored-value balance dips below a certain level or is insufficient to make a requested purchase.

If the user's Default funding option has passed its expiry date and a top-up (also referred to as a load or recurring load) is needed to complete the transaction, then a notification message is displayed “Your default funding option has expired. Please use an alternative funding option,” and the default funding option radio button is disabled.

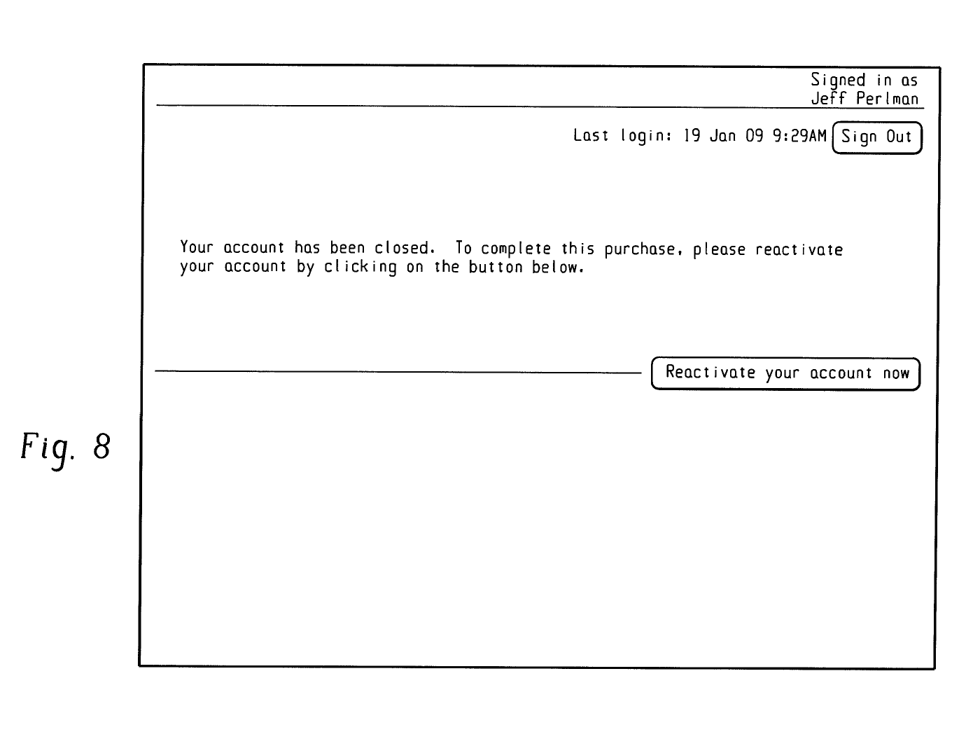

If a user who has closed his or her account to a read-only mode attempts to complete a transaction, he or she will receive an in-line screen which allows him or her to Reactivate his or her account and complete the transaction as shown in FIG. 8.

The service checks that the signed purchase message is valid (i.e., it was signed by the correct merchant and has not expired) and then checks the RecentTransactionLog table to determine if the transaction has already been processed.

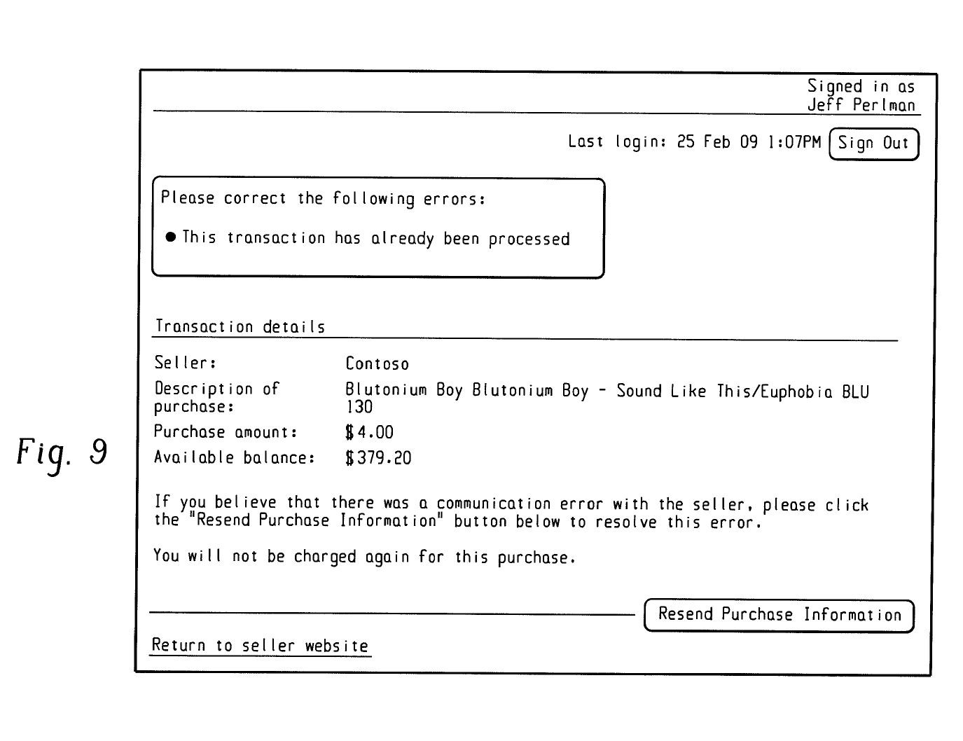

If the transaction is valid and has already been processed, then the user may be presented with a page showing the transaction summary, the message, “This transaction has already been processed. If you believe that there was a communication error with the merchant, please click the ‘Resend Purchase Information’ button below to resolve this error. You will not be charged again for this purchase.” (See FIG. 9.) The screen has a “Resend Purchase Information” button and a “Return to seller website” link.

When the user clicks the “Resend Purchase Information” button, a signed purchase response message will be generated from existing data in the Transaction log and posted back to the merchant, allowing the merchant site to re-post the successful transaction screen. The merchant will need to check for duplicate messages before fulfilling any order.

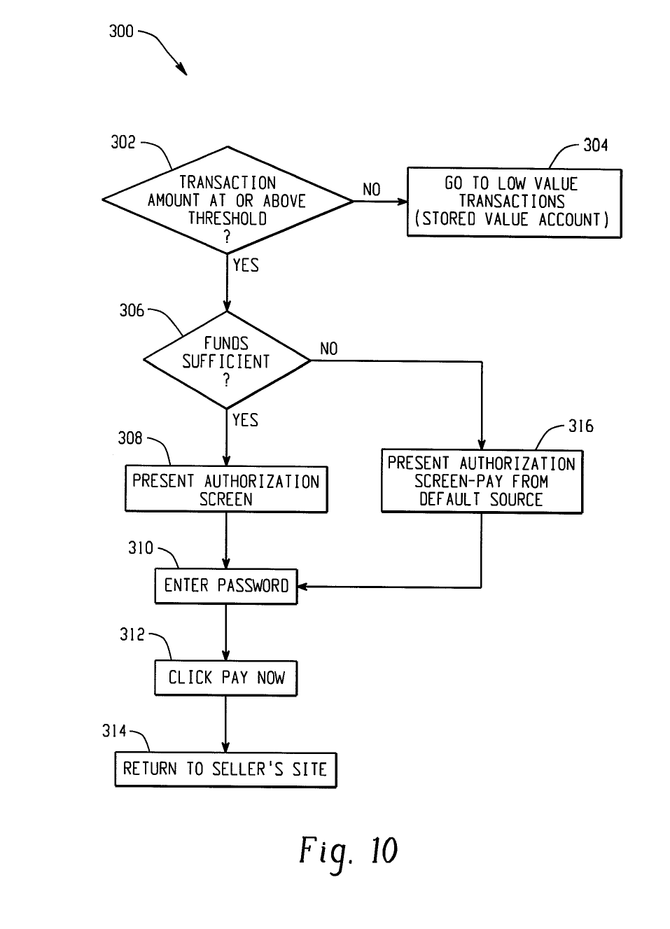

Another aspect of the present disclosure that enables the purchase of items above the “low-value threshold” using the service as a proxy, resulting in a direct transaction with the default payment source (or other saved payment source if manually selected) is illustrated in FIG. 10. This aspect of the service includes automated logic to alter the user experience based on: (1) the value of the transaction (above or below low-value threshold); (2) multiple rules and permutations of the higher-value transaction; (3) and the recording of the higher-value transactions separately from stored-value balance in transaction history.

The high-value direct transaction 300 illustrated in FIG. 10 begins at 302 by using the Low-Value Transaction Threshold as a parameter to trigger different behaviors in the Transaction Authorization process, with transaction rules dictating the transaction default to either the Stored-Value Account (below the Low-Value Threshold) or to a direct transaction to the default payment source (at or above the Low-Value Threshold) with several variations depending on the balance in the stored-value account, the availability of a saved default payment source, the ability to create a keyboardless express transaction session, and the type of seller account (e.g. standard, sponsored, etc.), among others, as discussed below. For example, the low-value threshold may be set at $20, $50, or $100.

If the Low-Value Transaction Threshold is set to $0, the service would effectively become a Direct Transaction only service. That is, all transactions would be treated as higher-value transactions. A Direct Transaction is a transaction directly sent to a payment source, such as a credit card, instead of prompting the user for additional information, such as information to fund a stored value account or to enter credit card information.

Alternatively, if the Low-Value Transaction Threshold was set at a number higher than any other maximum transaction value allowed by the Service, the Service would effectively become a Low-Value Transaction only service. For example, every transaction could require payment from a stored-value account.

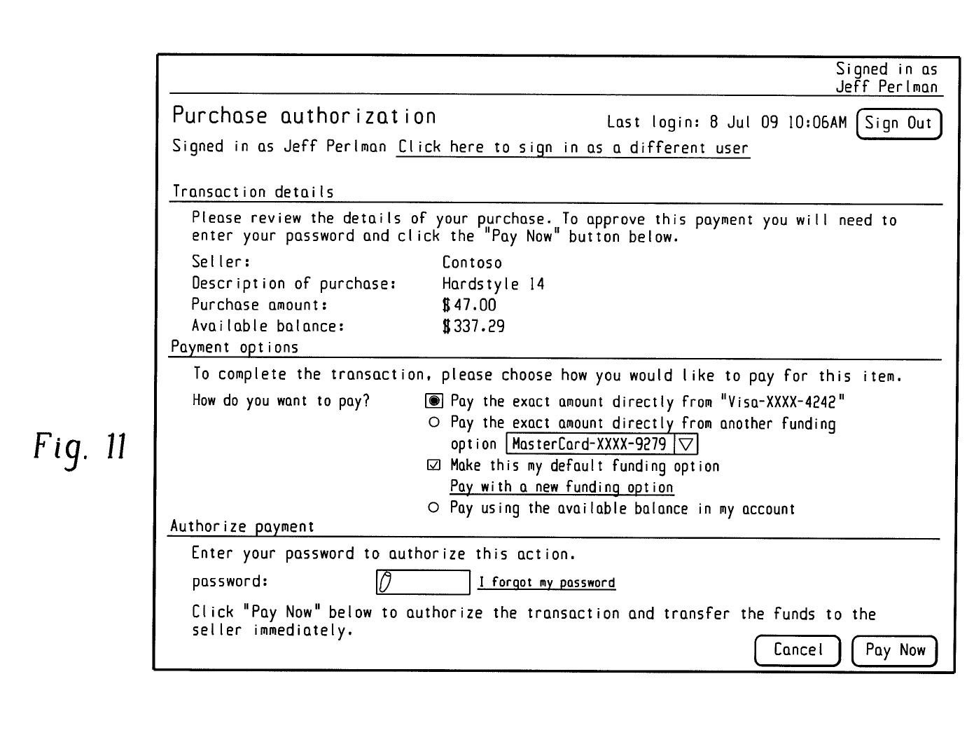

If a transaction amount is at or above the Low-Value Threshold as determined at 302, and the user also has sufficient funds for the transaction in his or her stored-value account as determined at 306, then the user will be presented with an Authorize Payment screen at 308 of the type shown in FIG. 11. The screen shown in FIG. 11 prompts the user (default) to pay for the transaction directly from his or her default funding source. This screen also gives the user the option to change to another funding source or to pay for the transaction from his or her stored value balance.

If the user's Default funding option has passed its expiry date, then a notification message is displayed “Your default funding option has expired. Please use an alternative funding option.” and the default funding option radio button is disabled. The transaction is authorized by entering the password at 310 and clicking on “Pay Now” at 312. Thereafter, the user is returned to the seller's site at 314 with a transaction response message. At this point the seller progresses the order accordingly, e.g., by providing a link to download a purchased song.

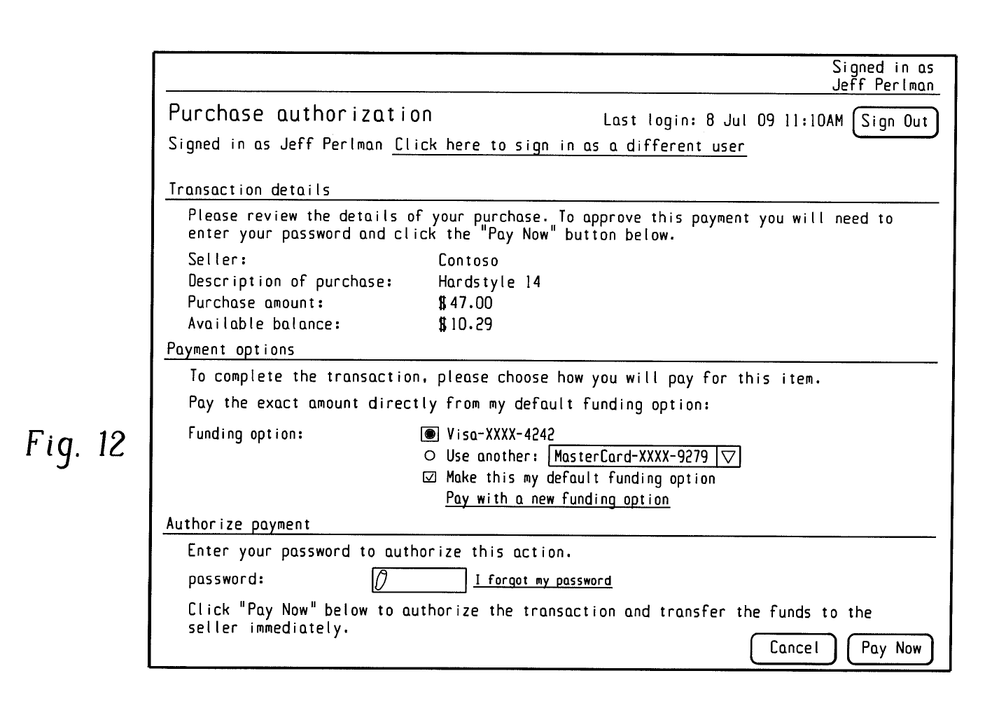

If a transaction amount is at or above the Low-Value Threshold and the user does not have sufficient funds for the transaction in his or her stored-value account, then the user will be presented with an authorize payment screen of the type shown in FIG. 12 which prompts the user (default) to pay for the transaction directly from his or her default funding source as shown by 316 in FIG. 10.

The screen shown in FIG. 12 also gives the user the option to change to another funding option but does not give the user the option to pay for the transaction from his or her stored value balance. If the user's Default funding option has passed its expiry date, then a notification message is displayed “Your default funding option has expired. Please use an alternative funding option.” and the default funding option radio button is disabled. The transaction is authorized by entering the password at 310 and clicking on “Pay Now” at 312.

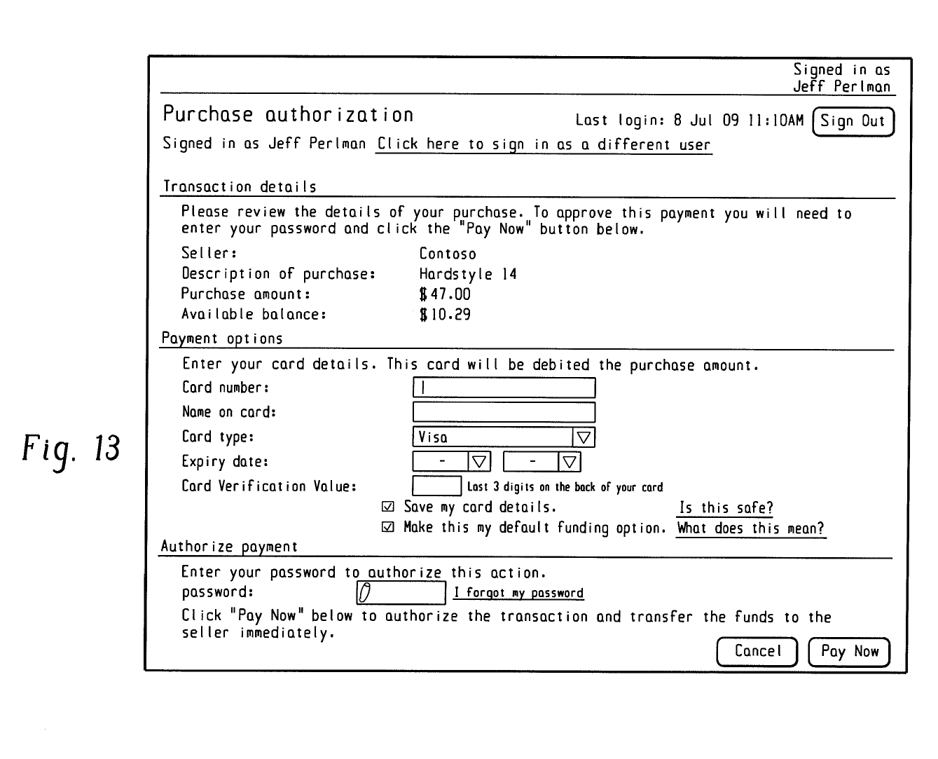

If the user has no payment card saved, then the Authorize Payment screen includes an Add a Card interface in lieu of the normal portion of the Authorize Payment interface that indicates the payment card which will by default be used. An example of such a screen is shown in FIG. 13. The user enters his or her card details, including having the option to save the details of the card, then enters his or her password to authorize the transaction with the seller directly from the card entered.

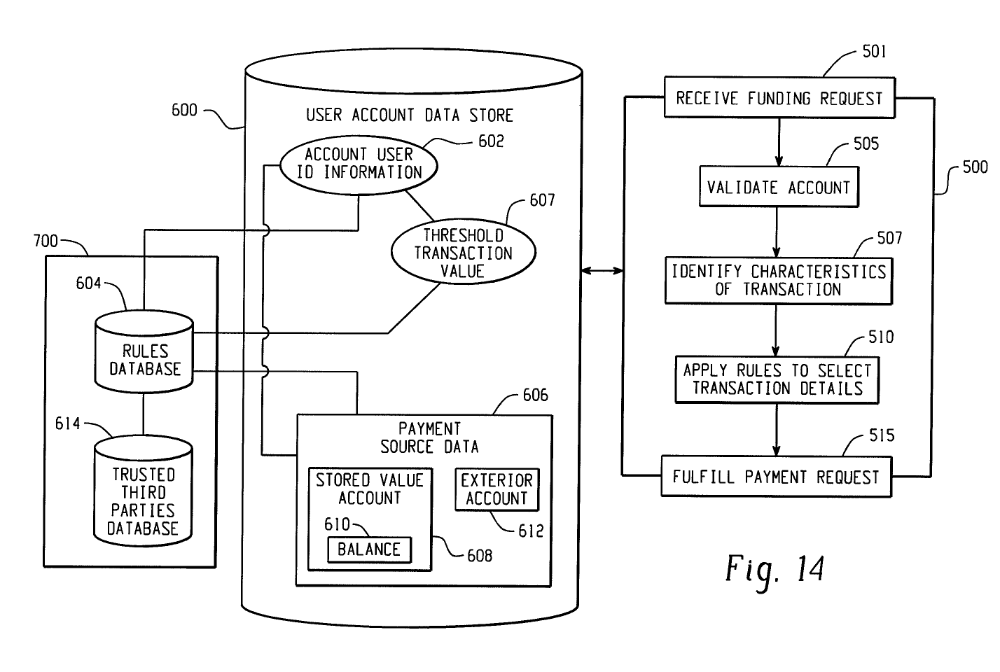

FIG. 14 is a flow-chart illustrating an example computer implemented method and funds facilitation system and data structure for processing transactions.

In the example method, a funding request is received from a source of the electronic funding request by the funds facilitation system 501 for funding a requested transaction. Such a request may be sent over the internet and received by one or more processors 500 operating in the funds facilitation system.

The processor 500 validates that the request is from/or on behalf of an authorized user 505 and that the user has a valid account on the system 505. The methods described above for validating the account/user and opening a new account may also be implemented in this example. Information from the user account data store 600, such as the account user ID information 602 may be accessed to perform the validation step 505.

The processor 500 identifies characteristics of the transaction based on information provided in the funding request 501, such as the transaction amount, the identity of the requesting source, the identity of the account-holder, and any additional rules or restrictions that the requesting source includes as an instruction in the transaction request message.

The processor 500 applies a set of transaction rules to select the transaction details 510 by comparing the characteristics of the transaction with the transaction rules stored in a rules database 604, which in turn is stored in the general data structure 700. The processor may also compare the characteristics of the transaction with the user account data store 600. The application of the transaction rules determines at least one of (a) a payment source for funding the funding request, (b) an authentication procedure for authenticating the funding request, (c) whether the request is from a new user and will require registration; (d) whether to categorize and record the transaction as a high-value or low-value transaction based on a threshold transaction amount; (e) whether to relay shipping information automatically to the source of the electronic funding request; and (f) other user account settings and data and other criteria described above. The transaction rules may be applied to determine all of these transactions details or a combination of any. The determination may be made either completely automatically, or may in some examples, provide default suggestions, which the user may override.

The information stored in the general data structure 700 may be applied to all account users, whereas the information stored in the user account data structure 600 is information specific to each individual user.

The user account data store 600 comprises account user ID information 602 that is associated with payment source data 606, a threshold transaction value 607, and the transaction rules database 604 (which reside in the general data structure 700). A threshold transaction value 607 may be associated with the account user ID information 602. Thus, each user may have a different threshold transaction value 607 associated with their account. The payment source data 606 includes information regarding a stored-value account 608, including a stored value balance 610. In this example, the payment source data 606 also includes information on an exterior account 612 (or default payment card as mentioned above), which may be a credit or debit card used for funding high value transactions or topping-up the stored value account balance 610.

The general data structure 700 contains the rules database 604 as mentioned above, and also includes a trusted third parties database 614, which contains information such as a list of trusted merchant websites, for which keyboardless transactions may be allowed.

The transaction rules are based on several items of data, as explained above. As depicted in FIG. 14, the transaction rules database 604 is associated with the payment source data 606, the stored-value account balance 608, the threshold transaction value 607, and the list of trusted third parties 614. For example, one transaction rule is that the funding request cannot be fulfilled from the stored-value account 608 if the stored-value account balance 610 is sufficient. If this were the case then the processor 500 would determine that the exterior account 612 would need to be utilized to fulfill the funding request.

The rules 604 determine the transaction details such as which payment source or sources 606 are used for fulfilling the funding request, and/or which authentication procedure is used. For example, a keyboardless transaction procedure may be used if the party requesting the payment is listed in the trusted third party database 614. The payment request is thus fulfilled according to the selected transaction details 515.

In one example, one or more payment sources are checked to determine if sufficient funds are available prior to attempting to fulfill the electronic funding request

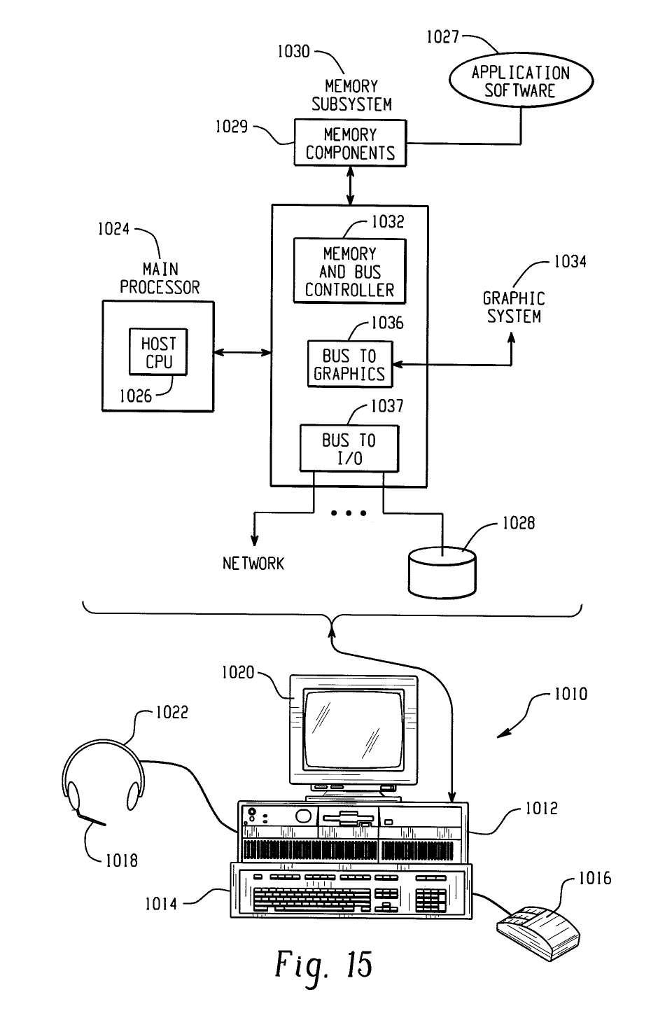

FIG. 15 is a block diagram of user hardware 1010 which may be used to implement the various embodiments of the method of the present invention at the user site. The hardware 1010 may be a personal computer system comprised of a computer 1012 having as input devices keyboard 1014, mouse 1016, and microphone 1018. Output devices, such as a monitor 1020 and speakers 1022, may also be provided. The reader will recognize that other types of input and output devices may be provided and that the present invention is not limited by the particular hardware configuration.

Residing within computer 1012 is a main processor 1024 which is comprised of a host central processing unit 1026 (CPU). Software applications 1027, such as the method of the present invention, may be loaded from, for example, disk 1028 (or other device), into main memory 1029 from which the software application 1027 may be run on the host CPU 1026. The main processor 1024 operates in conjunction with a memory subsystem 1030. The memory subsystem 1030 is comprised of the main memory 1029, which may be comprised of a number of memory components, and a memory and bus controller 1032 which operates to control access to the main memory 1029. The main memory 1029 and controller 1032 may be in communication with a graphics system 1034 through a bus 1036. Other buses may exist, such as a PCI bus 1037, which interfaces to I/O devices or storage devices, such as disk 1028 or a CDROM, or to provide network access.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus.

The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including, by way of example, a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method of processing transactions in a funds facilitation system, comprising:
receiving an electronic funding request to provide a payment for a transaction;
identifying characteristics of the transaction based on information provided in the funding request;
comparing the characteristics of the transaction with transaction rules stored in a rules database to determine at least one of:
(a) a payment source for funding the funding request, and
(b) an authentication procedure for authorizing the funding request, wherein
selection of the authentication procedure is based at least in part on a stored trust level associated with a source of the electronic funding request;
the receiving, identifying, and comparing steps being performed by software executable on one or more data processors.

2. The method of claim 1 wherein the characteristics of the transaction are further identified based on information contained in a user account data store of the funds facilitation system.

3. The method of claim 1 wherein one or more payment sources are checked to determine if sufficient funds are available prior to attempting to fulfill the electronic funding request.

4. The method of claim 1, wherein the step of comparing the characteristics of the transaction with transaction rules stored in the rules database determines both:
(a) a payment source for funding the funding request, and
(b) an authentication procedure for authenticating the funding request.

5. The method of claim 1, further comprising determining whether a transaction amount of the transaction is at or above a threshold amount.

6. The method of claim 5, wherein if the transaction amount is not at or above the threshold amount, then selecting a stored-value account payment source.

7. The method of claim 1, wherein the rules are applied to select the payment source and authentication procedure without user interaction.

8. The method of claim 1, wherein if the trust level associated with the source of the electronic funding request is sufficient, then selecting a keyboardless authentication procedure.

9. The method of claim 5, wherein if the trust level associated with the source of the electronic funding request is sufficient, and if the transaction amount is not at or above the threshold amount, then selecting a keyboardless authentication procedure.

10. The method of claim 1, wherein the step of comparing the characteristics of the transaction with transaction rules stored in a rules database further comprises determining at least one of:
whether the request is from a new user and will require registration;
whether to categorize and record the transaction as a high-value or low-value transaction based on a threshold transaction amount; and
whether to relay shipping information automatically to the source of the electronic funding request.

11. The method of claim 2, further comprising sending a customized authorization to the source of the electronic funding request based on information contained in the user account data store.

12. The method of claim 2, wherein if sufficient funds are not available in a stored-value account, adding funds to the stored-value account and funding the funding request from the stored-value account or funding the funding request from another payment source.

13. The method of claim 1, wherein at least one transaction rule is based on at least one of:
system or user set value parameters that associate specific payment sources with specific value thresholds or ranges; a spend limit based on merchant or merchant type; a merchant category and restrictions which may apply to the merchant category independent of or in combination with user account information; whether a user account is verified as safe harbor, unverified, or sponsored; a category of item being purchased and restrictions applying to the category of item, independent of or in combination with the user account; geographic location of the party requesting funding in relation to the geographic location of a user specified in the user account data; a condition allowing the transactions only if the transaction can be funded from a specific funding source.

14. A computer-implemented system comprising:
a funds facilitation system, a user account data store, a payment source, and a trusted third-parties database;
one or more processors operating to: receive an electronic funding request to provide a payment for a transaction, identify characteristics of the transaction based on information provided in the funding request, and compare the characteristics of the transaction with transaction rules stored in a rules database to determine at least one of:
(a) a payment source for funding the funding request, and
(b) an authentication procedure for authorizing the funding request, wherein selection of the authentication procedure is based at least in part on a stored trust level associated with a source of the electronic funding request.

15. The system of claim 14, wherein the processor determines whether one or more payment sources have sufficient funds available prior to attempting to fulfill the electronic funding request.

16. The system of claim 14, wherein the processor determines whether the transaction amount is at or above a threshold amount.

17. The system of claim 16, wherein if the transaction amount is not at or above the threshold amount, then selecting a stored-value account payment source.

18. The system of claim 14, wherein the rules are applied to select the payment source and authentication procedure without user interaction.

19. The system of claim 14, wherein if the trust level associated with the source of the electronic funding request is sufficient, then selecting a keyboardless authentication procedure.

20. The system of claim 14, wherein the processor by comparing the characteristics of the transaction with transaction rules stored in the rules database, determines both:
(a) a payment source for funding the funding request, and
(b) an authentication procedure for authorizing the funding request.

21. The system of claim 20, wherein the processor further operates to determining at least one of:
whether the request is from a new user and will require registration;
whether to categorize and record the transaction as a high-value or low-value transaction based on a threshold transaction amount; and
whether to relay shipping information automatically to the source of the electronic funding request.

22. The system of claim 14, wherein at least one transaction rule is based on at least one of:
system or user set value parameters that associate specific payment sources with specific value thresholds or ranges; a spend limit based on merchant or merchant type; a merchant category and restrictions which may apply to the merchant category independent of or in combination with user account information; whether a user account is verified as safe harbor, unverified, or sponsored; a category of item being purchased and restrictions applying to the category of item, independent of or in combination with the user account; geographic location of the party requesting funding in relation to the geographic location of a user specified in the user account data; a condition allowing the transactions only if the transaction can be funded from a specific funding source.

23. A memory for storing data for access by an account processor in a funds facilitation system, comprising:
a user account data structure comprising account user ID information associated with payment source data, the payment source data comprising stored-value account information, a stored-value account balance, an additional account information;
the account user ID information further associated with a threshold transaction value;
a general data structure comprising
(1) a rules database comprising rules for determining at least one of: (a) a payment source for funding the funding request, and (b) an authentication procedure for authorizing the funding request; and
(2) an authentication database comprising a list of trusted third parties,
the rules database being associated with the stored-value account balance, the threshold transaction value, and the trusted third party database.

24. A computer-implemented system for processing transactions, comprising:
means for receiving an electronic funding request to provide a payment for a transaction;
means for identifying characteristics of the transaction based on information provided in the funding request;
means for comparing the characteristics of the transaction with transaction rules stored in a rules database to determine at least one of:
(a) a payment means for funding the funding request, and
(b) an authentication means for authorizing the funding request, wherein selection of the authentication means is based at least in part on a stored trust level associated with a source of the electronic funding request.

25. The system of claim 24, further comprising means for checking one or more payment means to determine if sufficient funds are available prior to attempting to fulfill the electronic funding request.

26. The system of claim 22, further comprising means for determining whether a transaction amount of the transaction is at or above a threshold amount.

27. The system of claim 24, further comprising selecting a stored-value account payment means if the transaction amount is not at or above the threshold amount.

28. The system of claim 22 wherein if the trust level associated with the source of the electronic funding request is sufficient, then selecting a keyboardless authentication procedure.
